(19) United States
(12) Patent Application Publication
(10) Pub. No.: US 2008/0244604 A1
(43) Pub. Date: Oct. 2, 2008

(54) Method for task and resource management

(76) Inventors: Bud J. Bennington, Lacon, IL (US); Michael R. Fetcho, East Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/729,790

(22) Filed: Mar. 30, 2007

(51) Int. Cl. G06F 9/46

(52) U.S. Cl. 718/104

(57) ABSTRACT

A method is disclosed for task and human resource management. In one embodiment, the method stores a plurality of first tasks, each first task including at least one first task skill. In addition, the method receives a search request, the search request including at least one search request skill. The method determines, based on the one or more first tasks, if one or more of the at least one first task skills corresponds to the at least one search request skill. In addition, the method determines one or more second tasks when it is determined that one or more of the at least one first task skills corresponds to the at least one search request skill. The one or more second tasks are determined from the plurality of first tasks. The method provides the determined one or more second tasks to a human resource. Further, the method receives a request from the human resource to be associated with at least one of the determined one or more second tasks, and associates the human resource with the at least one of the determined one or more second tasks.

### TECHNICAL FIELD

The present disclosure relates generally to systems and methods for knowledge management, and more particularly, to a system and method for managing one or more tasks and resources.

### BACKGROUND

Businesses have a continuing need to effectively manage their resources in view of work tasks and requirements. Resources may include, for example, employees and the like who have skills or abilities in one or more areas and who may apply these skills or abilities to complete one or more work tasks. These skills may include, for example, technical skills, business or interpersonal skills, management skills, educational levels, spoken or written languages, computer languages, etc. Work tasks may include any work item or project that a business may seek to perform. These work tasks may be required or elective, and may or may not be related to the core activities with which the business is involved.

A business may have limited resources having a desired set of skills relative to the number of work tasks available or the amount of time required to complete certain work tasks. Thus, the business may need to identify resources having the best fit of skills for a given work task. In order to do that, the business may identify the skills required for any given work task as well as the skills maintained by its resources. Using this information, the business may then negotiate the application of one or more resources to one or more tasks.

Systems and methods have been created for arrangement of resource and work-item selection. One such example is U.S. Pat. No. 7,035,808 (the '808 patent) to Ford issued on Apr. 25, 2006. The '808 patent discloses a workflow system employing a selection engine that attempts to match work items with resources. The selection engine of the '808 patent determines either those available resources that possess skills needed by an available work item or those available work items that need skills possessed by an available resource. In addition, the selection engine of the '808 patent determines, for each determined resource, both a business value of having that resource service the work item and either a value to that resource of servicing the work item or a value to that work item of being serviced by the resource. Based on these determinations, the selection engine of the '808 patent selects the resource that has a best combined value of the business value and the value to the resource or work item.

Although the system and method of the '808 patent may select a resource based on a determined value of the resource, the system and method do not provide for flexibility in dynamically allocating tasks and/or resources. Once calculations are performed, the system and method of the '808 patent determines the task allocation, and is unable to dynamically change the allocation of tasks and resources. The system and method of the '808 patent does not allow for the allocation of resources and/or tasks according to a combination of business requirements and resource needs or wants. Thus, the system of the '808 patent does not provide mechanisms to allow distribution of tasks in accordance with resource preference.

The disclosed embodiments are directed to overcoming one or more of the problems set forth above.

### SUMMARY OF THE INVENTION

In one aspect, the present disclosure is directed to a method for managing one or more tasks or human resources. The method stores a plurality of first tasks, each first task including at least one first task skill. In addition, the method receives a search request, the search request including at least one search request skill. The method determines, based on the plurality of first tasks, if one or more of the at least one first task skills corresponds to the at least one search request skill. In addition, the method determines one or more second tasks when it is determined that one or more of the at least one first task skills corresponds to the at least one search request skill. The one or more second tasks are determined from the plurality of first tasks. The method provides the determined one or more second tasks to a human resource. Further, the method receives a request from the human resource to be associated with at least one of the determined one or more second tasks, and associates the human resource with the at least one of the determined one or more second tasks.

In another aspect, the present disclosure is directed to a computer-readable medium, including instructions for performing, when executed by a processor, a method for managing one or more tasks or human resources. The processor stores a plurality of first tasks, each first task including at least one first task skill. In addition, the processor receives a search request, the search request including at least one search request skill. The processor determines, based on the plurality of first tasks, if one or more of the at least one first task skills corresponds to the at least one search request skill. In addition, the processor determines one or more second tasks when it is determined that one or more of the at least one first task skills corresponds to the at least one search request skill, wherein the one or more second tasks are determined from the plurality of first tasks. The processor provides the determined one or more second tasks to a human resource. Further, the processor receives a request from the human resource to be associated with at least one of the determined one or more second tasks, and associates the human resource with the at least one of the determined one or more second tasks.

In another aspect, the present disclosure is directed to a system for managing one or more tasks or human resources. The system includes at least one memory storing data and instructions and at least one processor configured to access the memory. The at least one processor is further configured to store one or more first tasks, each first task including at least one first task skill. In addition, the at least one processor is configured to receive a search request, the search request including at least one search request skill. The at least one processor is also configured to determine, based on the one or more first tasks, if one or more of the at least one first task skills corresponds to the at least one search request skill. In addition, the at least one processor is also configured to determine one or more second tasks when it is determined that at least one of the one or more first task skills corresponds to the at least one search request skill, wherein the one or more second tasks are determined from the plurality of first tasks. The at least one processor is configured to provide the determined one or more second tasks to a human resource. Further, the at least one processor is also configured to receive a request from the human resource to be associated with at least one of the determined one or more second tasks, and associate the human resource with the at least one of the determined one or more second tasks.

### BRIEF DESCRIPTION OF THE DRAWINGS

FIG. 1 is a block diagram of an exemplary system consistent with certain disclosed embodiments;

FIG. 2 is a flow chart illustrating an exemplary process for determining task priority consistent with certain disclosed embodiments;

FIGS. 3a, 3b, 3c, and 3d are screen shots of exemplary interfaces used for determining task priority consistent with certain disclosed embodiments;

FIG. 4 is a flow chart illustrating an exemplary process for determining task priority consistent with certain disclosed embodiments;

FIG. 5 is a screenshot of an exemplary interface used for task and resource management consistent with certain disclosed embodiments;

FIGS. 6a and 6b are exemplary graphical representations of task priority consistent with certain disclosed embodiments;

FIG. 7 is a flow chart illustrating an exemplary process for managing tasks and resources consistent with certain disclosed embodiments;

FIG. 8 is a screenshot an exemplary interface used for task and resource management consistent with certain disclosed embodiments;

FIG. 9 is a flow chart illustrating an exemplary process for task and resource management consistent with certain disclosed embodiments; and

FIG. 10 is a flow chart illustrating an exemplary process for task and resource management consistent with certain disclosed embodiments.

### DETAILED DESCRIPTION

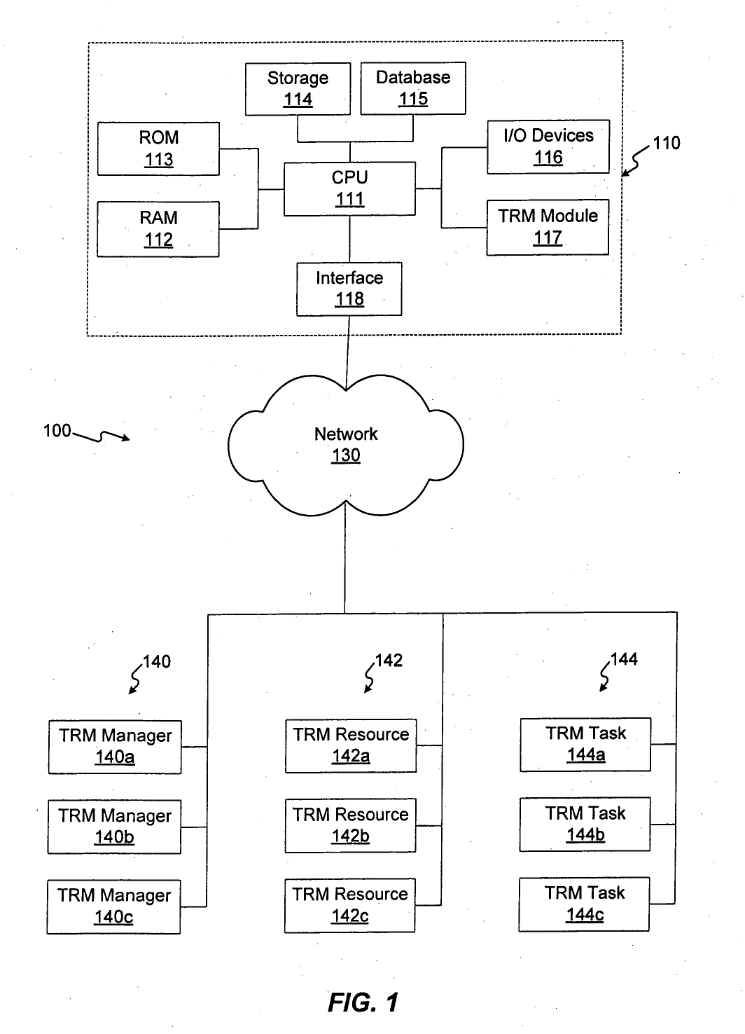

FIG. 1 illustrates an exemplary system architecture 100 for which systems and methods consistent with the disclosed embodiments may be implemented. As shown in FIG. 1, system architecture 100 may include one or more hardware and/or software components configured to display, collect, store, analyze, evaluate, distribute, report, process, record, and/or sort information associated with task and resource management, including determining task priority. System architecture 100 may include Task and Resource Management (TRM) computing system 110, network 130, one or more TRM managers 140 (e.g., TRM manager 140a, TRM manager 140b, and TRM manager 140c), one or more TRM resources 142 (e.g., TRM resource 142a, TRM resource 142b, and TRM resource 142c), and one or more TRM tasks 144 (e.g., TRM task 144a, TRM task 144b, and TRM task 144c).

TRM computing system 110 may be configured to receive, collect, analyze, evaluate, report, display, and distribute data related to task and resource management. For example, TRM computing system 110 may include one or more of a central processing unit (CPU) 111, a random access memory (RAM) 112, a read-only memory (ROM) 113, a storage 114, a database 115, input/output (I/O) device 116, Task and Resource Management (TRM) module 117, and interface 118. TRM computing system 110 may be a server, client, mainframe, desktop, laptop, network computer, workstation, personal digital assistant (PDA), tablet PC, scanner, telephony device, pager, and the like. In one embodiment, TRM computing system 110 may be a computer configured to receive and process information associated with task and resource management. In addition, one or more constituent components of TRM computing system 110 may be co-located with any one or more business units, facilities, warehouses, sales and/or distribution centers, manufacturing sites, and the like.

CPU 111 may include one or more processors, each configured to execute instructions and process data to perform functions associated with TRM computing system 110. As illustrated in FIG. 1, CPU 111 may be connected to RAM 112, ROM 113, storage 114, database 115, I/O device 116, TRM module 117, and interface 118. CPU 111 may be configured to execute computer program instructions to perform various processes and methods consistent with certain disclosed embodiments. In one exemplary embodiment, computer program instructions may be loaded into RAM 112 for execution by CPU 111.

RAM 112 and ROM 113 may each include one or more devices for storing information associated with an operation of TRM computing system 110 and/or CPU 111. For example, ROM 113 may include a memory device configured to access and store information associated with TRM computing system 110, including information for identifying, initializing, and monitoring the operation of one or more components and subsystems of TRM computing system 110. RAM 112 may include a memory device for storing data associated with one or more operations of CPU 111. For example, instructions stored on ROM 113 may be loaded into RAM 112 for execution by CPU 111.

Storage 114 may include any type of storage device configured to store any type of information used by CPU 111 to perform one or more processes consistent with the disclosed embodiments. For example, storage 114 may include one or more magnetic and/or optical disk devices, such as, for example, hard drives, CD-ROMs, DVD-ROMs, a universal serial bus (USB) port, a floppy, or any other type of mass media device.

Database 115 may include one or more software and/or hardware components that store, organize, sort, filter, and/or arrange data used by TRM computing system 110 and/or CPU 111. Database 115 may store one or more tables, lists, or other data structures containing data associated with task and resource management. For example, database 115 may store information associated with tasks, such as, for example, task title, task number, short task description, long task description, estimated number of resource hours required to complete the task, estimated number and/or type of resources required to complete the task, a dollar value (e.g., actual or estimated dollar values associated with performing the work, cost avoidances, time savings, increased sales, revenue increases, cost savings, etc.), business value of the task (e.g., employee satisfaction, public regard, customer satisfaction, etc.), risk associated with the task (e.g., legal risks, economic risks, business risks, etc.), costs associated with the task (e.g., costs of skilled resources, costs of unskilled resources, fixed costs, equipment costs, etc.), forced change data (e.g., data associated with changed required due to statutory compliance, regulatory compliance, litigation avoidance, etc.), task start date, task end date, etc. The information stored by database 115 may be used by CPU 111 to receive, categorize, prioritize, save, send, and/or manage data associated with task and resource management. In addition, database 115 may store additional and/or different information than that listed above.

I/O device 116 may be one or more I/O devices and each I/O device may include one or more components configured to communicate information associated with TRM computing system 110. For example, I/O device 116 may include a console with an integrated keyboard and mouse to allow a user to input data associated with TRM computing system 110 and/or data associated with one or more tasks, one or more resources, and task and resource management. I/O device 116 may include one or more displays or other peripheral devices, such as, for example, printers, cameras, microphones, speaker systems, electronic tablets, bar code readers, scanners, or any other suitable type of I/O device 116.

TRM module 117 may include one or more software programs and/or instructions configured to perform processes consistent with certain disclosed embodiments. For example, TRM modules 117 may include a computer program product stored on TRM computing system 110 and configured to be executed by CPU 111 to perform one or more processes for receiving and processing information associated with task and resource management. Although TRM module 117 is shown as a separate module in TRM system 110, TRM module 117 may be implemented in one or more other components of TRM computing system 110.

Interface 118 may include one or more components configured to transmit and receive data via network 130, such as, for example, one or more modulators, demodulators, multiplexers, de-multiplexers, network communication devices, wireless devices, antennas, modems, and any other type of device configured to enable data communication via any suitable communication network. Interface 118 may also be configured to provide remote connectivity between CPU 111, RAM 112, ROM 113, storage 114, database 115, one or more input/output (I/O) devices 116, and/or TRM modules 117 to collect, analyze, and distribute data associated with task and resource management.

TRM computing system 110 may store data associated with actions performed in association with the disclosed method. For example, TRM computing system 110 may record data associated with creating, accessing, viewing, editing, storing, etc. of TRM tasks 144, the identity and access rights of the entity creating, accessing, viewing, editing, saving, etc. TRM tasks 144, and any changes made to data associated with TRM tasks 144. As another example, TRM computing system 110 may record data associated with creating, accessing, viewing, editing, storing, etc. of TRM resources 142, the identity and access rights of the user creating, accessing, viewing, editing, and/or saving TRM resources 142, and any changes made to data associated with TRM resources 142. In addition, TRM computing system 110 may store information associated with accessing, viewing, editing, saving, etc. of task and resource management, and the like. In one embodiment, TRM computing system 110 may display the stored information as a subset of data within a displayed TRM task 144, or may display the stored information as a separate file. In either case, the information may be available for later access and/or viewing. In one exemplary embodiment, one or more internal and/or external individuals and/or groups may access and view the stored information. The one or more internal and/or external individuals and/or groups may include, for example, auditing personnel, regulatory personnel, legal personnel, law enforcement personnel, security personnel, etc.

TRM computing system 110 may include additional, fewer, and/or different components than those listed above and it is understood that the listed components are exemplary only and not intended to be limiting. For example, one or more of the hardware components listed above may be implemented using software. In one exemplary embodiment, storage 114 may include a software partition associated with one or more other hardware components of TRM computing system 110. Additional hardware or software may also be used to operate TRM computing system 110, such as, for example, security applications, authentication systems, dedicated communication systems, etc. The hardware and/or software may be interconnected and accessed by authorized users. In addition, a portion, or all of, TRM computing system 110 may be hosted and/or operated remotely from TRM computing system 110 using, for example, commercial servers, commercial application providers, and the like.

Network 130 may be any network that allows communication between or among one or more computing systems, such as, for example, the Internet, a local area network, a wide area network, a metropolitan area network, a broadband network, a workstation peer-to-peer network, a direct link network, a wireless network, or any other suitable communication network. Connection with network 130 may be wired, wireless, or any combination thereof. In one exemplary embodiment, TRM managers 140, TRM resources 142, and TRM tasks 144 may be connected to TRM computing system 110 through network 130.

TRM managers 140 (e.g., TRM managers 140a, 140b, and 140c) may include any individual and/or group of individuals associated with owning, granting, updating, viewing, or otherwise managing tasks and/or resources. In one exemplary embodiment, TRM managers 140 may include one or more resource managers who may be responsible for the management of one or more resources. In another exemplary embodiment, TRM managers 140 may include one or more project managers who may be responsible for the management of one or more work projects or tasks. TRM resources 142 (e.g., TRM resources 142a, 142b, and 142c) may include any individual or group having one or more resource skills and associated resource skill levels. In one exemplary embodiment, TRM resources 142 may include full-time employees, part-time employees, interns (paid and unpaid), agency or contract personnel, employees and/or agents of joint venture companies or similar business partners, suppliers, vendors, dealers, contractors, sub-contractors, etc. In some embodiments, TRM resources 142 may also include facilities, equipment, tools, software and/or hardware, etc. Resource skills may be abilities or achievements associated with a resource. Resource skills may include, for example, technical skills (e.g., skills related to equipment, facilities, tools, software, hardware, computer languages, etc.), business and/or interpersonal skills (e.g., skills related to communication, research and planning, human relations, organization, management, leadership, etc.), educational achievements and/or levels (e.g., skills related to formal education, informal education, training courses, certifications, etc.), licensing and/or certification (e.g., bonding, licensing, registration, etc.), spoken or written languages, etc.

Resource skill levels may represent a level of proficiency, achievement, or mastery for an associated resource skill. In addition, resource skill levels may represent other data that may be used to define a resource skill. For example, if the resource skill is education, resource skill levels may include an educational level (e.g., high school, vocational school, college, university, etc.), degree or certification, grades, evaluations, etc. A plurality of resource skill levels may be associated with each resource skill. Resource skill levels may be represented in TRM computing system 110 alphanumerically, visually, descriptively, and the like. For example, TRM computing system 110 may associate an alphanumeric code with an education level such as a four-year college degree. In addition, TRM computing system 110 may define resource skill levels hierarchically. For example, an education level may include sub-categories such as, for example, a degree, degree type, degree field, grade point average (GPA), etc. Resource skill levels may be determined objectively, subjectively, or any combination thereof. For example, an educational level may be determined objectively, whereas the resource skill level associated with a communication level may be determined subjectively. Resource skill levels may be determined by TRM manager 140, TRM resource 142, or any other entity or combination of entities authorized to affect resource skills and resource skill level data stored in TRM computing system 110. In one exemplary embodiment, resource skills and/or skill levels may be reported by TRM resource 142. For instance, TRM resource 142 may select and store its own resource skills and/or resource skill levels. Alternatively and/or additionally, resource skills and/or skill levels may be determined as part of a review or feedback process. For example, one or more TRM managers 140 may select and store resource skills and/or resource skill levels associated with TRM resources 142 following completion of one or more TRM tasks 144.

TRM tasks 144 (e.g., TRM tasks 144a, 144b, and 144c) may each include one or more work items or combination of work items. For example, TRM tasks 144 may include projects, components of projects, sub-components of projects, and the like, each of which may include one or more work items. In one exemplary embodiment, TRM computing system 110 may determine TRM tasks 144 by means of a “trouble ticket,” “trouble report,” or the like. Trouble tickets and trouble reports may include any mechanisms used to track the detection, reporting, and resolution of some type of problem or desired work effort. In some embodiments, TRM computing system 110 may generate one or more TRM task 144 automatically by means of software and/or hardware when one or more specified or predetermined conditions are met. Specified or predetermined conditions may include, for example, error conditions (i.e., an error has been encountered), maintenance conditions (i.e., conditions have been met that may initiate routine or emergency maintenance requests), threshold conditions (i.e., a threshold has been met and/or passed), and the like. For example, if a software program encounters an error condition, the software program may automatically generate one or more TRM tasks 144 in TRM computing system 110. Alternatively and/or additionally, a user may generate one or more TRM tasks 144. The user may be any person or group of persons associated with the business and may include, for example, TRM managers 140, TRM resources 142, owners, employees, agents, customers, vendors, business partners, etc.

Task skills may be abilities or achievements determined to be associated with the completion of TRM task 144. Task skills may include, for example, technical skills (e.g., skills related to equipment, facilities, tools, software, hardware, computer languages, etc.), business and/or interpersonal skills (e.g., skills related to communication, research and planning, human relations, organization, management, leadership, etc.), educational achievements and/or levels (e.g., skills related to formal education, informal education, training courses, certifications, etc.), licensing and/or certification (e.g., bonding, licensing, registration, etc.), spoken or written languages, etc.

Task skill levels may represent a level of proficiency, achievement, or mastery for an associated resource skill. In addition, task skill levels may represent other data that may be used to define a task skill. For example, if the task skill is education, task skill levels may include an educational level (e.g., high school, vocational school, college, university, etc.), degree or certification, grades, evaluations, etc. A plurality of task skill levels may be associated with each task skill. Task skill levels may be represented in TRM computing system 110 alphanumerically, visually, descriptively, and the like. For example, TRM computing system 110 may associate an alphanumeric code with an education level such as a four-year college degree. In addition, TRM computing system 110 may define task skill levels hierarchically. For example, an education level may include sub-categories such as, for example, a degree, degree type, degree field, grade point average (GPA), etc. Task skill levels may be determined objectively, subjectively, or any combination thereof. For example, an educational level may be determined objectively, whereas the task skill level associated with a communication level may be determined subjectively. Task skill levels may be determined by TRM manager 140, TRM resource 142, or any other entity or combination of entities authorized to affect task skills and task skill level data stored in TRM computing system 110.

Task skills and/or task skill levels may correspond to resource skills and/or resource skill levels. A task skill may correspond to a resource skill when, for example, the resource skill and task skill are the same, equivalent, comparable, substitutable, etc. In other words, a task skill may correspond to a resource skill when TRM resource 142 may apply that resource skill towards the completion of TRM task 144. Task skills and/or task skill levels may be stored in database 115 of TRM computing system 110.

TRM managers 140 and TRM resources 142 may access TRM computing system 110 by means of one or more computing devices (i.e., desktop, laptop, mainframe, server, client, handheld computing device, personal digital assistant, telephony device, tablet PC, bar code reader, scanner, etc.) and various other hardware and/or software components (not shown). The one or more computing devices may allow TRM managers 140 and TRM resources 142 to connect to and communicate with TRM computing system 110 by means of network 130.

The business entity may include divisions, groups, sections, departments, branches, etc. that interact as sub-entities for the business entity. In some embodiments, the sub-entities entities may have a business relationship with one another. For example, one or more sub-entities may be a user of a good supplied by a supplier sub-entity within the same business entity, such as a manufacturing business with supply division, production line division, etc.

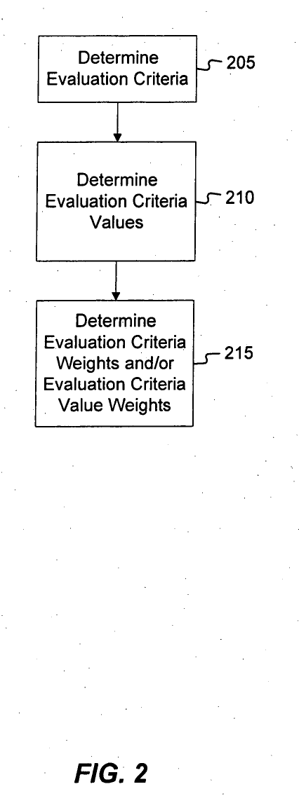

FIG. 2 illustrates a flowchart of an exemplary process for task and resource management consistent with certain disclosed embodiments. The process of FIG. 2 may be performed by TRM computing system 110. For example, TRM computing system 110 may execute one or more software programs that may perform one or more of the process steps of FIG. 2.

Referring to FIG. 2, a business entity may determine one or more evaluation criteria associated with a business entity (step 205). The business entity may include any person and/or groups of persons associated with the business and may include, for example, TRM managers 140, TRM resources 142, owners, employees, agents, customers, vendors, business partners, etc. TRM computing system 110 may use the evaluation criteria to perform calculations associated with task and resource management. The evaluation criteria may include any type of criteria by which a business may assess one or more TRM tasks 144. Evaluation criteria may include objective criteria, subjective criteria, or any combination thereof. The evaluation criteria may include, for example, dollar values (e.g., actual or estimated dollar values associated with performing the work, cost avoidances, time savings, increased sales, revenue increases, cost savings, etc.), business values (e.g., employee satisfaction, public regard, customer satisfaction, etc.), levels of effort (e.g., number of resources, resource hours, etc.), risks to the business entity (e.g., risks in completing task, risks in not completing task, potential litigation costs, potential product failure, etc.), return on investment, forced changes (e.g., changes required to ensure statutory compliance, regulatory compliance, compliance with legal judgments, litigation avoidance, etc.), etc.

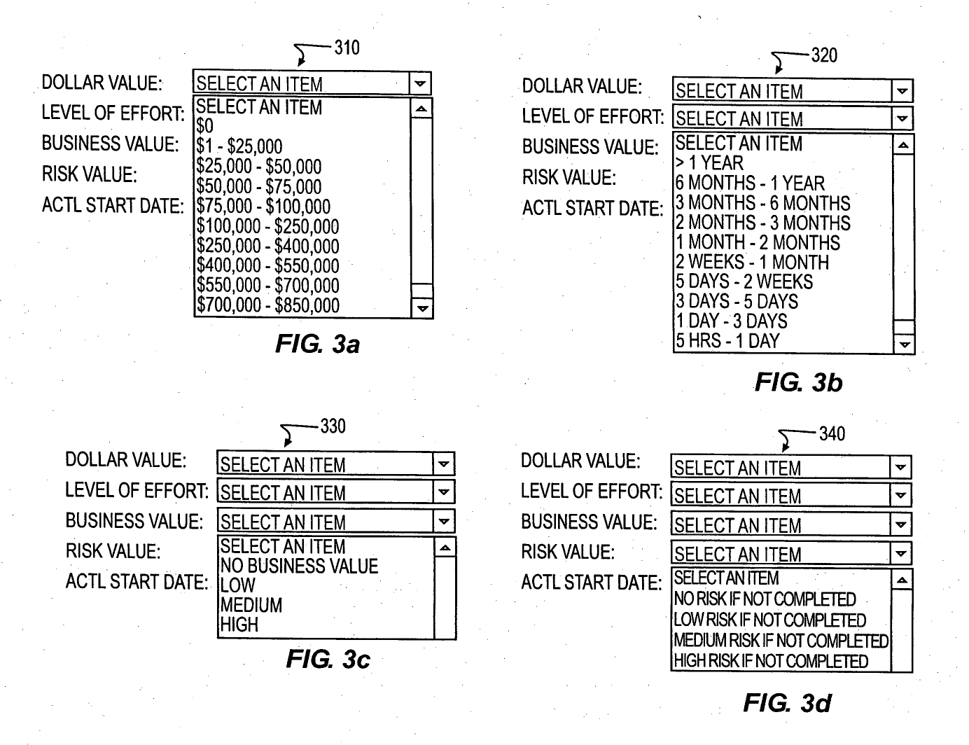

Once the evaluation criteria are determined, the business entity may then determine one or more evaluation criteria values associated with the evaluation criteria (step 210). Evaluation criteria values may be one or more values used to define evaluation criteria. In one exemplary embodiment, referring to item 310 of FIG. 3a, Dollar Value evaluation criteria values may include a selection of dollar value ranges. For example, Dollar Value evaluation criteria values may include $0, $1-$25,000, $25,000-$50,000, $50,000-$75,000, $75,000-$100,000, $100,000-$250,000, $250,000-$400,000, $400,000-$550,000, $550,000-$700,000, $700,000-$850,000, etc. Referring to item 320 of FIG. 3b, Level of Effort evaluation criteria values may include a selection of time periods. For example, Level of Effort evaluation criteria values may include >1 year, 6 months-1 year, 3 months-6 months, 2 months-3 months, 1 month-2 months, 2 weeks-1 month, 5 days-2 weeks, 3 days-5 days, 1 day-3 days, 5 hours-1 day, etc. As shown by item 330 of FIG. 3c, Business Evaluation criteria values may include a selection of value assessments. For example, Business Evaluation criteria values may include a selection of No Business Value, Low, Medium, High, etc. Referring to item 340 of FIG. 3d, Level of Risk evaluation criteria values may include a selection of possible risk assessments. For example, Level of Risk evaluation criteria values may include a selection of “No risk if not completed,” “Low risk if not completed,” “Medium risk if not completed,” “High risk if not completed,” etc. In addition, TRM computing system 110 may also display other information. For example, TRM computing system 110 may provide editable fields for start date (e.g., actual start date, estimated start date, etc.) and work effort reference number (e.g., trouble ticket number, trouble report number, etc.) available for selection, viewing, and/or entry of data.

The business entity may determine one or more weights associated with evaluation criteria (i.e., evaluation criteria weights) and/or weights associated with evaluation criteria values (i.e., evaluation criteria value weights) (step 215). The evaluation criteria weights and/or evaluation criteria value weights may include, for example, numerical values, mathematical formulas, etc. In one exemplary embodiment, TRM computing system 110 may use the one or more evaluation criteria weights and/or evaluation criteria value weight to ensure uniformity of the evaluation criteria and/or evaluation criteria value. In one embodiment, a business entity may weight evaluation criteria associated with TRM tasks 144 having a predetermined evaluation criteria value a higher weighting value. For example, TRM computing system 110 may associate a higher weighting value with TRM tasks 144 having an evaluation criteria value of “Forced Change” (i.e., a change that is required).

In some embodiments, the one or more evaluation criteria, evaluation criteria values, evaluation criteria weights, and/or evaluation criteria value weights may be evaluated and adjusted periodically. In addition, a business entity may periodically re-evaluate the evaluation criteria, evaluation criteria values, evaluation criteria weights, and/or evaluation criteria value weights. Such re-evaluation may occur at any time. Alternatively and/or additionally, the business entity and/or TRM computing system 110 may adjust the one or more evaluation criteria weights and/or evaluation criteria value weights dynamically. For example, the business entity and/or TRM computing system 110 may adjust the one or more evaluation criteria weights and/or evaluation criteria value weights at any time during the process of task and resource management, as disclosed herein. In one exemplary embodiment, TRM computing system 110 may dynamically adjust the one or more evaluation criteria weights and/or evaluation criteria value weights when one or more predetermined conditions are met. These predetermined conditions may include, for example, one or more periods of time (e.g., automatically increasing/decreasing after a certain period of time, etc.), a number of TRM tasks 144 (e.g., adjust evaluation criteria weights and/or evaluation criteria value weights when the number of TRM tasks 144 increases, adjust evaluation criteria weights and/or evaluation criteria value weights when the number of TRM tasks 144 decreases, etc.), etc.

The evaluation criteria, evaluation criteria values, evaluation criteria weights, and/or evaluation criteria value weights may be different for each business entity or business sub-entity. For instance, a first business sub-entity may be associated with a first set of evaluation criteria, first set of evaluation criteria values, first set of evaluation criteria weights, and first set of evaluation criteria value weights. A second business sub-entity may be associated with a second set of evaluation criteria, second set of evaluation criteria values, second set of evaluation criteria weights, and second set of evaluation criteria value weights. Alternatively, different business entities or sub-entities may share one or more evaluation criteria, evaluation criteria values, evaluation criteria weights, and evaluation criteria value weights. For example, a first business sub-entity and a second business sub-entity may share similar evaluation criteria and evaluation criteria values but the first and second business sub-entities may have different evaluation criteria weights, and/or evaluation criteria value weights. In certain embodiments, TRM computing system 110 may use any combination of shared and/or differing evaluation criteria, evaluation criteria values, evaluation criteria weights, and evaluation criteria value weights.

TRM computing system 110 may store the evaluation criteria, evaluation criteria values, evaluation criteria weights, and/or evaluation criteria value weights in database 115. TRM computing system 110 may use the evaluation criteria, evaluation criteria values, evaluation criteria weights, and/or evaluation criteria value weights to perform the process of task and resource management according to certain disclosed embodiments, as discussed herein.

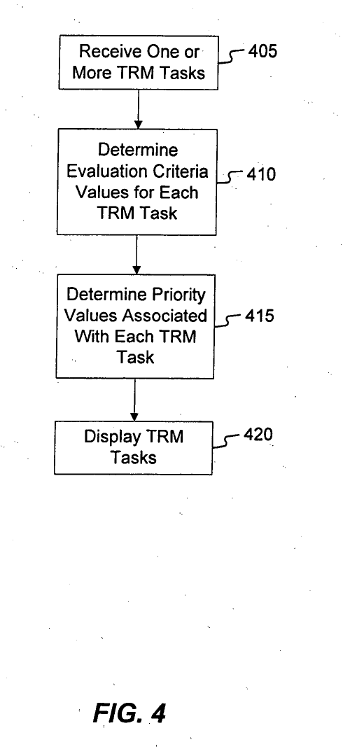

FIG. 4 illustrates a flowchart of an exemplary process for TRM task prioritization associated with TRM task and resource management consistent with certain disclosed embodiments. The process of FIG. 4 may be performed by TRM computing system 110. For example, TRM computing system 110 may execute one or more software programs that may perform one or more of the process steps of FIG. 4.

Referring to FIG. 4, once the evaluation criteria, evaluation criteria values, evaluation criteria weights, and/or evaluation criteria value weights are determined, TRM computing system 110 may receive one or more TRM tasks 144 (step 405). In one embodiment, one or more users may generate TRM tasks 144. The user may be any person or group associated with the business and may include, for example, TRM managers 140, TRM resources 142, owners, employees, agents, customers, vendors, business partners, etc. The user may generate one or more TRM tasks 144 by means of a computing system operable to communicate with TRM computing system 110. Alternatively and/or additionally, computer software and/or hardware may automatically generate one or more TRM tasks 144. In one exemplary embodiment, TRM computing system 110 may receive TRM tasks 144 and store TRM tasks 144 in database 115.

As discussed above in connection with FIG. 2, a business entity may have determined one or more evaluation criteria and one or more associated evaluation criteria values. Thus, for each evaluation criterion, TRM computing system 110 may provide the determined one or more evaluation criteria and one or more associated evaluation criteria values. For example, TRM computing system 110 may provide the determined one or more evaluation criteria and one or more associated evaluation criteria values using drop-down boxes, alphanumeric entry fields, radio buttons, check boxes, scrollable lists, menu bars, text fields, and the like.

From the available choices, a user may select one or more evaluation criteria values for each TRM task 144 (step 410). For example, referring to FIGS. 3a-3d, the following evaluation criteria values may be selected for TRM task 144: Dollar Value=$75,000-$100,000, Level of Effort=6 months-1 year, Business Value=Medium, and Risk Value−Medium risk if not completed. In one exemplary embodiment, TRM manager 140 and/or TRM resource 144 may select the evaluation criteria values associated with each evaluation criterion for a specific TRM task 144.

TRM computing system 110 may calculate one or more priority values for each TRM task 144 based on the selected evaluation criteria values, as discussed above in connection with step 410, and/or the weighting values associated with each evaluation criteria and/or evaluation criteria value, as discussed above in connection with step 215 of FIG. 2, (step 415). In one embodiment, TRM computing system 110 may determine the one or more priority values using a mathematical calculation or formula that takes into account the selected evaluation criteria values and their associated weighted value for a given business entity. TRM computing system 110 may indicate the priority value for each TRM task 144 using any communication mechanism, such as, for example, verbal, aural, alphanumeric, graphical, pictorial, color, and the like. In one exemplary embodiment, TRM computing system 110 may indicate the priority value using a number. For example, TRM computing system 110 may indicate a higher priority using a relatively larger number and may indicate a lower priority using a relatively smaller number. In another exemplary embodiment, TRM computing system 110 may indicate the priority value using a color. For example, red may indicate the highest priority, orange may indicate the second highest priority, yellow may indicate the third highest priority, and so on. Alternatively and/or additionally, TRM computing system 110 may indicate priority by the order of TRM tasks 144 in a table, list, or other data structure.

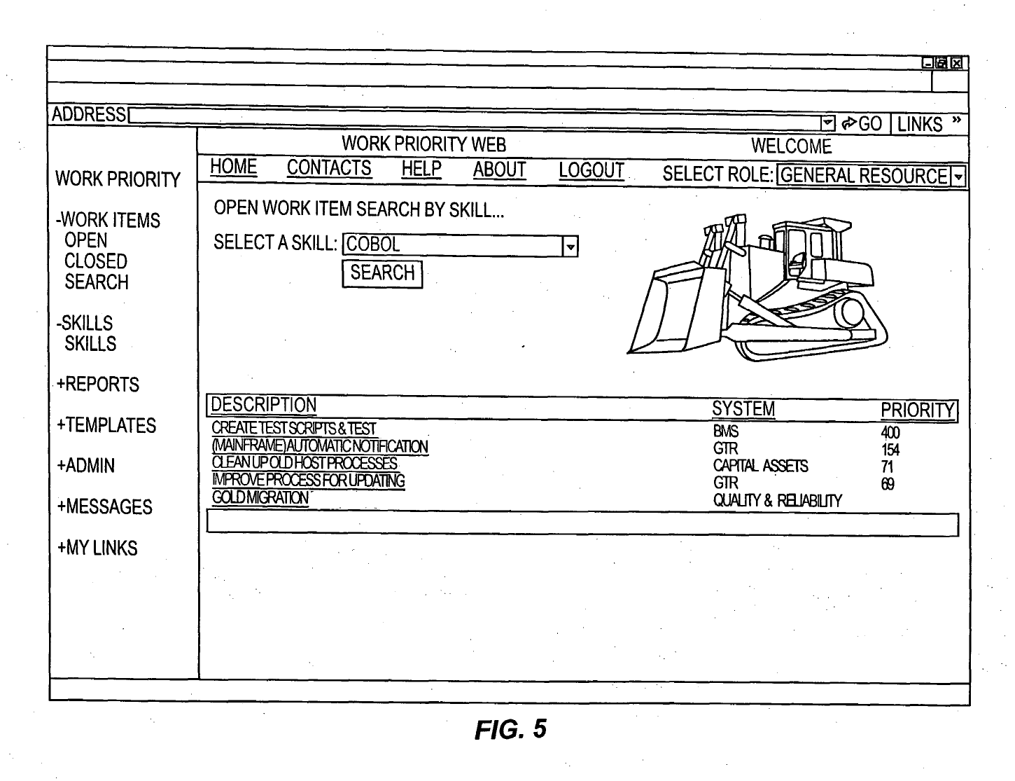

In addition, TRM computing system 110 may display the one or more prioritized TRM tasks 144 (step 420). In one exemplary embodiment, TRM computing system 110 may display the one or more TRM tasks 144 based on the determined priority values. In another exemplary embodiment, TRM computing system 110 may display one or more TRM tasks 144 in a table, list, or other similar means, and the one or more TRM tasks 144 may be ordered or grouped according to the one or more priority values. For example, FIG. 5 shows a screenshot of an exemplary interface 500 reflecting a plurality of TRM tasks 144, each with an associated numerical priority value.

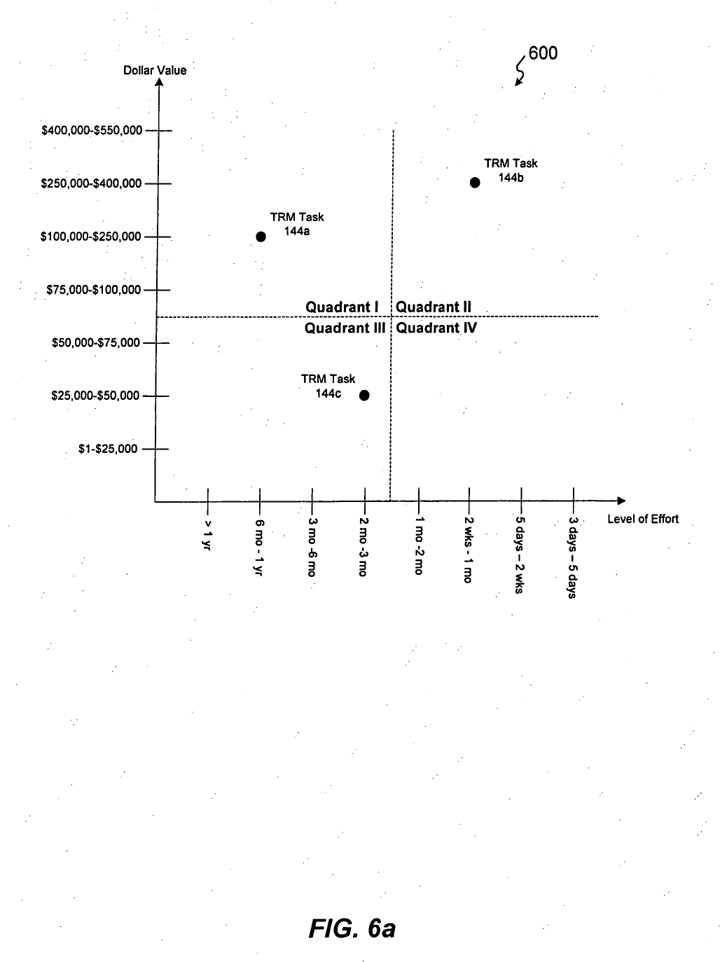

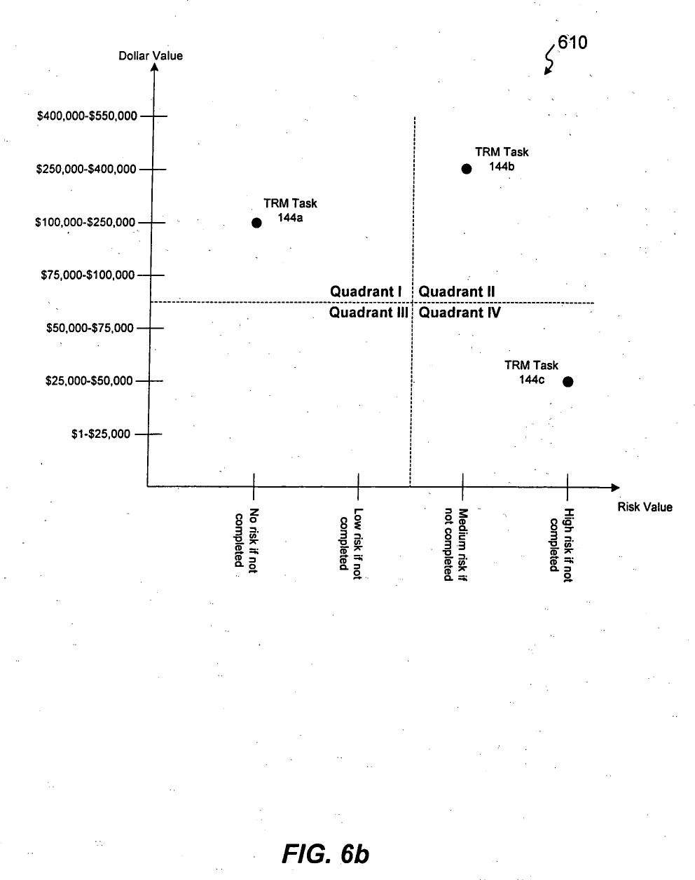

In another exemplary embodiment, TRM computing system 110 may graphically display the one or more TRM tasks 144 based on one or more evaluation criteria and evaluation criteria values. For example, TRM computing system 110 may use evaluation criteria to define the X- and Y-axis, and may use evaluation criteria values to define points along the X- and Y-axis. Alternatively and/or additionally, TRM computing system 110 may use weighted evaluation criteria values to define points along the X- and Y-axis. For example, referring to FIG. 6a, TRM computing system 110 may display the Dollar Value evaluation criterion along the Y-axis, and may display the Level of Effort evaluation criterion along the X-axis. TRM computing system 110 may then divide the graph into quadrants. For example, TRM computing system 110 may define or associate TRM tasks 144 (e.g., TRM task 144a) falling within Quadrant I as High Value/High Effort, TRM tasks 144 (e.g., TRM task 144b) falling within Quadrant II as High Value/Low Effort, TRM tasks 144 (e.g., Task C) falling within Quadrant III as Low Value/Low Effort, and TRM tasks 144 (not shown) falling within Quadrant IV as Low Value/High Effort. Thus, TRM computing system 110 may determine priority based on the Quadrant within which a TRM task 144 is found. In this example, TRM computing system 110 may prioritize TRM tasks 144 in the following order: High Value/Low Effort (Quadrant II), High Value/High Effort (Quadrant I), Low Value/Low Effort (Quadrant III), and Low Value/High Effort (Quadrant IV).

As another example, referring to FIG. 6b, TRM computing system 100 may display the Dollar Value evaluation criterion along the Y-axis, and may display the Risk Value evaluation criterion along the X-axis. In this example, TRM computing system 100 may define or associate TRM tasks 144 (e.g., TRM task 144a) falling within Quadrant I as High Value/Low Failure to Complete Risk, TRM tasks 144 (e.g., TRM task 144b) falling within Quadrant II as High Value/High Failure to Complete Risk, TRM tasks 144 (not shown) falling within Quadrant III as Low Value/Low Failure to Complete Risk, and TRM tasks 144 (e.g., TRM task 144c) falling within Quadrant IV as Low Value/High Failure to Complete Risk. In this example, TRM computing system 110 may prioritize TRM tasks 144 in the following order: High Value/High Failure to Complete Risk (Quadrant II), Low Value/High Failure to Complete Risk (Quadrant IV), High Value/Low Failure to Complete Risk (Quadrant I), and Low Value/Low Failure to Complete Risk (Quadrant III).

Alternatively and/or additionally, TRM computing system 110 may further refine quadrants to prioritize within sub-quadrants, and TRM computing system 110 may prioritize these sub-quadrants relative to sub-quadrants within the same quadrant and/or sub-quadrants in other quadrants. Further, TRM computing system 110 may interleave priority of one or more sub-quadrants in a first quadrant with one or more sub-quadrants of a second quadrant. For example, Quadrant I may include four sub-quadrants (e.g., sub-quadrants Ia-Id) and Quadrant II may also include four sub-quadrants (e.g., sub-quadrants IIa-IId). In this example, TRM computing system 110 may prioritize the sub-quadrants in the following order: sub-quadrant Ia, sub-quadrant Ib, sub-quadrant IIa, sub-quadrant IIb, sub-quadrant Ic, sub-quadrant IIc, sub-quadrant Id, and sub-quadrant IId. Although only quadrants and sub-quadrants are discussed, it is to be understood that prioritization may be achieved to any level of refinement as is practicable, desirable, and/or necessary.

TRM managers 140, TRM resources 142, and/or any other user or group associated with the business entity may dynamically determine X- and Y-axis evaluation criteria, quadrants, sub-quadrants, etc., as discussed above. For example, TRM manager 140 may dynamically change an X-axis evaluation criteria from Dollar Value to Level of Effort, and the Y-axis evaluation criteria from Level of Effort to Dollar Value.

From the numerical prioritization, tabular prioritization, graphical prioritization, and the like, the business entity may perform task and resource management. For example, according to certain disclosed embodiments, a business entity (e.g., Business ABC) may first define one or more evaluation criteria. For instance, an exemplary Business ABC may define the evaluation criteria of Dollar Value, Level of Effort, Business Value, and Risk Value using interfaces in FIG. 3a-3d. Business ABC may also define a number of evaluation criteria values associated with the evaluation criteria, as also described above and shown in FIGS. 3a-3d. In this example, Business ABC may weight each evaluation criteria and evaluation criteria values by 1.0. However, Business ABC may associate a weight value with the evaluation criteria and/or evaluation criteria values using any value or formula. Business ABC may also reevaluate the evaluation criteria, evaluation criteria values, and/or evaluation criteria weights at any time.

Further, in this example, a project manager for Business ABC, John Smith, may enter one or more tasks into TRM computing system 110. To do so, the project manager may access TRM computing system 110 and enter a task description. Thus, John Smith may enter other information associated with the task, such as, for example, an estimated amount of time required to complete the task, estimated number of resource hours, etc. TRM computing system 110 may determine reference numbers to associate with each of the entered tasks for tracking or identification (e.g., ticket number, tracking number, etc. In this example, John Smith may enter three tasks, TRM task 144a, TRM task 144b, and TRM task 144c.

A TRM manager 144 (e.g., TRM manager 144a) may review TRM tasks 144a, 144b, and 144c to determine values associated with the Dollar Value, Level of Effort, Business Value, and Risk Value. For example, for TRM task 144a, TRM manager 144a may select a Dollar Value=$100,000-$250,000, Level of Effort=6 months-1 year, Business Value=Medium, and Risk Value=No Risk if Not Completed. For TRM task 144b, TRM manager 144a may select a Dollar Value=$250,000-$400,000, Level of Effort=2 weeks-1 month, Business Value=Medium, and Risk Value=Medium Risk if Not Completed. For TRM task 144c, TRM manager 144a may select a Dollar Value=$25,000-$50,000, Level of Effort=2 months-3 months, Business Value=Medium, and Risk Value=High Risk if Not Completed. TRM computing system 110 may then graphically display the selected values as shown in one example, FIGS. 6a and 6b.

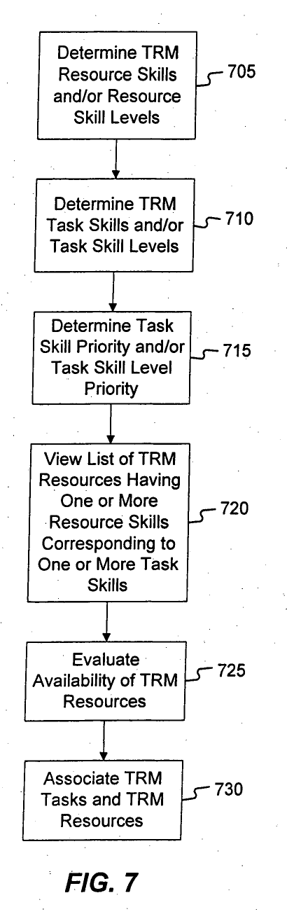

FIG. 7 illustrates a flowchart of an exemplary process for TRM resource and task assignment associated with TRM task and resource management, consistent with certain disclosed embodiments. The process of FIG. 7 may be performed by TRM computing system 110. For example, TRM computing system 110 may execute one or more software programs that may perform one or more of the process steps of FIG. 7.

Referring to FIG. 7, TRM manager 140 and/or TRM resource 142 may determine and store one or more resource skills and/or resource skill levels associated with one or more TRM resources 142 (step 705). In one exemplary embodiment, database 115 may store one or more lists and/or sets of selectable skills, and the user may determine the one or more resource skills and/or resource skill levels from the one or more lists and/or sets stored by database 115 using one or more discrete editable fields. For example, TRM manager 140 and/or TRM resource 142 may determine and store resource skills and/or resource skill levels using drop-down boxes, alphanumeric entry fields, radio buttons, check boxes, scrollable lists, menu bars, and the like. In one exemplary embodiment, TRM manager 140 and/or TRM resource 142 may enter supporting text for each resource skill and/or resource skill level. Additionally and/or alternatively, TRM computing system 110 may parse resource skills from textual documents associated with TRM resources 142, such as, for example, resumes, curriculum vitaes, transcripts, job applications, surveys, etc. and stored in database 115. Once resource skills and/or resource skill levels are selected for a given TRM resource 142, TRM computing system 110 may store the selected resource skills and/or resource skill levels in database 115. Stored resource skills and/or resource skill levels may be accessed, viewed, edited, searched, and the like for use in the process of task and resource management according to certain disclosed embodiments.

For each TRM task 144, TRM manager 140 and/or TRM resource 142 may determine and store one or more task skills and/or task skill levels in TRM computing system 110 (step 710). TRM manager 140 and/or TRM resource 142 may enter one or more task skills and/or task skill levels using one or more discrete editable fields including, for example, drop-down boxes, alphanumeric entry fields, radio buttons, check boxes, scrollable lists, menu bars, and the like. In some embodiments, TRM computing system 110 may store task skills and/or task skill levels in database 115.

TRM manager 140 and/or TRM resource 142 may determine a task skill priority and/or task skill level priority for each task skill and/or task skill level, respectively, of each TRM task 144 (step 715). TRM manager 140 and/or TRM resource 142 may determine task skill priority using one or more discrete editable fields including, for example, drop-down boxes, alphanumeric entry fields, radio buttons, check boxes, scrollable lists, menu bars, and the like. In one exemplary embodiment, TRM computing system 110 may use task skill priority and/or task skill level priority to, for example, prioritize one or more task skills relative to one or more other task skills. Additionally and/or alternatively, TRM computing system 110 may use task skill priority and/or task skill level priority to associate one or more TRM resources 142 with a TRM task 144. For example, TRM computing system 110 may associate a TRM resource 142 with a high resource skill level for a given resource skill with a TRM task 144 having a high priority for a corresponding task skill.

TRM computing system 110 may provide a representation of task skill priority using any type of communication mechanism, such as, for example, verbal, aural, alphanumeric, graphical, pictorial, color, and the like. In one exemplary embodiment, TRM computing system 110 may represent task skill priority using a number. In another exemplary embodiment, TRM computing system 110 may represent task skill priority using a color. For example, red may represent a first priority, orange may represent a second priority, yellow may represent a third priority, and so on. Alternatively and/or additionally, TRM computing system 110 may represent task skill priority by the order of TRM tasks 144 in a table or list.

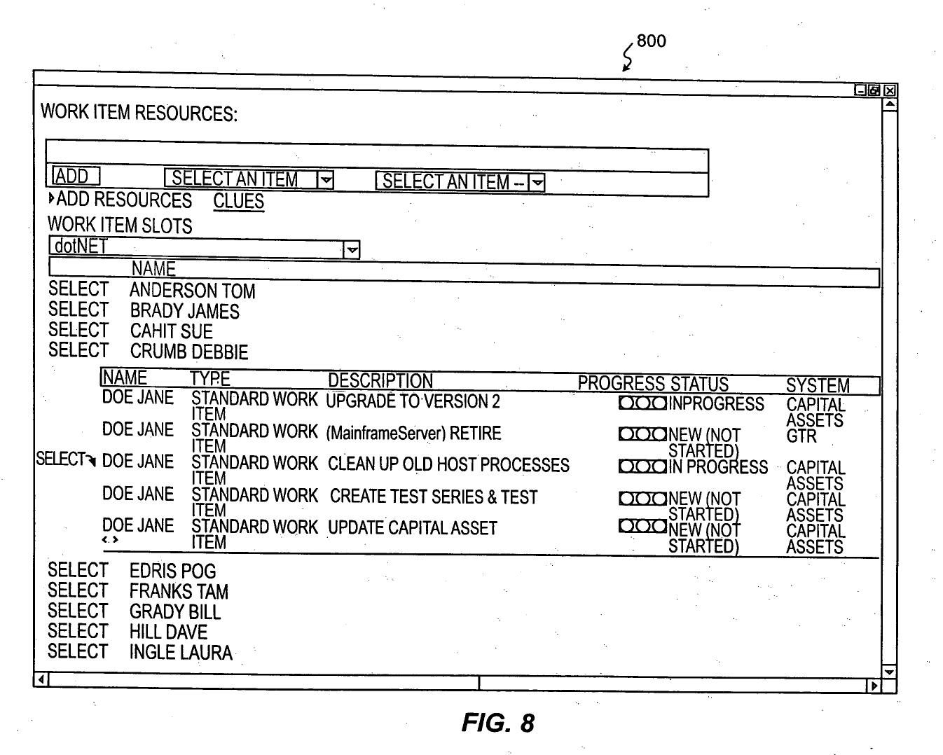

Once one or more task skills and/or task skill levels have been determined for TRM task 144, TRM manager 140 may view a list of TRM resources 142 having one or more resource skills corresponding to the one or more determined task skills (step 720). In one exemplary embodiment, TRM computing system 110 may determine the list of TRM resources 142 based on a selected resource skill. TRM manager 140 and/or TRM resource 142 may select a resource skill using, for example, one or more discrete editable fields including, for example, drop-down boxes, alphanumeric entry fields, radio buttons, check boxes, scrollable lists, menu bars, and the like. For example, referring to an exemplary screenshot 800 as in FIG. 8, TRM manager 140 may select a resource skill “dotNET” from a drop-down menu. In response, TRM computing system 110 may display a list of TRM resources 142 having the resource skill “dotNET.” As shown in FIG. 8, any number of TRM resources 142 having the selected resource skill may be determined and displayed. In one exemplary embodiment, if there are no TRM resources 142 having the selected resource skill, TRM computing system 110 may display no TRM resources 142. Alternatively, if there are more TRM resources 142 having the selected resource skill than can be displayed in a single screen, TRM computing system 110 may provide multiple screens, each including TRM resources 142 determined to have the selected resource skill.

In another exemplary embodiment, TRM computing system 110 may automatically generate the list of TRM resources 142. For example, TRM computing system 110 may evaluate one or more task skills associated with TRM task 144 and may generate a list of TRM resources 142 determined to have the closest correspondence between one or more resource skills and one or more task skills. TRM computing system 110 may generate the list of TRM resources 142 based on, for example, a single task and/or resource skill, multiple task and/or resource skills, priority of one or more task skills, resource skill level, etc. TRM computing system may display the determined TRM resources 142 in any order. For example, TRM computing 110 may list TRM resources 142 determined to have a selected resource skill in ascending or descending alphabetical order by name, ascending or descending order of resource skill level for the associated selected resource skill, ascending or descending current work level of the TRM resource 142, etc. In one exemplary embodiment, the list of TRM resources 142 may include an indication of time available to allocate for one or more TRM tasks 144. The indication may be provided for each TRM resource 142 and/or groups of TRM resources 142. The indication may be represented using any type of communication mechanism including, for example, verbal, aural, alphanumeric, graphical, pictorial, color, and the like. In one exemplary embodiment, the indication may be represented by a number. For example, a numerical indication may be provided, and the numerical indication may be the number of hours or other measure of available time that TRM resource 142 has available to apply toward one or more TRM tasks 144. Alternatively and/or additionally, the numerical indication may be the number of hours or other measure of available time that TRM resource has allocated toward one or more TRM tasks 144. In another exemplary embodiment, the indication may be represented by a color. For example, red may indicate that TRM resource 142 has little or no available time (e.g., the time available is less than and/or equal to a predetermined amount of time, etc.). On the other hand, the color green may be used to indicate that TRM resource 142 has a greater amount of available time (e.g., the time available is greater than and/or equal to a predetermined amount of time, etc.). Other colors may be implemented to provide indications of varying amounts of available time. Alternatively and/or additionally, an indication may be provided in the form of prioritized list of TRM resources 142 presented in a table, list, or data structure.

TRM manager 140 may then evaluate the availability of the displayed TRM resources 142 (step 725). Evaluating the availability of displayed TRM resources 142 may include evaluating a current task workload associated with a TRM resource 142, evaluating a task progress of one or more TRM tasks 144 associated with a TRM resource 142, evaluating a task status of one or more TRM tasks 144 associated with a TRM resource 142, etc. TRM manager 140 may repeat the evaluation of available TRM resources 142 for each displayed TRM resource 142 and thereby determine one or more TRM resources 142 with which one or more TRM tasks 144 may be associated. For example, in response to TRM manager 140 selecting a TRM resource 142 on a display interface, TRM computing system 110 may display all TRM tasks 144 associated with the selected TRM resource 142, as shown in the screenshot of exemplary interface 800 of FIG. 8. As also shown in FIG. 8, all TRM tasks 144 associated with Jane Doe may be displayed in interface 800. Alternatively and/or additionally, TRM computing system 110 may automatically evaluate the availability of the displayed TRM resources 142. For example, TRM computing system 110 may evaluate a current task workload associated with a TRM resource 142. For example, TRM computing system 110 may evaluate a task progress of one or more TRM tasks 144 associated with a TRM resource 142, evaluate a task status of one or more TRM tasks 144 associated with a TRM resource 142, etc. TRM computing system 110 may display or report a summary and/or a result of the evaluation to TRM manager 140, TRM resource 142, etc.

In addition, TRM computing system 110 may display task progress indicators and/or task status indicators for each TRM task 144 associated with a TRM resource 142. Task progress indicators may provide an indication of current progress of work on TRM task 144. Task progress may be represented using any type of communication mechanism including, for example, verbal, aural, alphanumeric, graphical, pictorial, color, and the like. In one exemplary embodiment, task progress may be represented by a number. In another exemplary embodiment, a task progress may be represented by a color. For example, red may indicate that TRM task 144 has not achieved an expected level of progress or completion. On the other hand, the color green may be used to indicate that TRM task 144 has achieved or exceeded an expected level of progress or completion. Other colors may be implemented to provide indications of varying degrees of task progress or completion. Alternatively and/or additionally, a task progress may be indicated in the form of prioritized list of TRM tasks 144 presented in a table, list, or data structure.

Task status indicators may indicate a current status of TRM task 144. Examples of task status indicators may include, for example, Pending/Not Reviewed, New/Not Started, In Progress, On Hold, Completed, Canceled, etc. A task status indicator of Pending/Not Reviewed may indicate that TRM task 144 has been created but has not been processed, as discussed above in connection with FIG. 4. A task status indicator of New/Not Started may indicate that TRM task 144 has been created and reviewed, as discussed above in connection with FIG. 4, but work on TRM task 144 has not begun. In addition, a task status indicator of New/Not Started may indicate that one or more TRM resources has been associated with TRM task 144. A task status indicator of In Progress may indicate that TRM task 144 has been created and reviewed, one or more TRM resources 142 has been associated with TRM task 144, and work on TRM task 144 has begun. A task status indicator of On Hold may indicate that TRM task 144 has been created, but work on TRM task 144 is not currently in progress. In some embodiments, a task status indicator of On Hold may also indicate that TRM task 144 has been reviewed and one or more TRM resources 142 have been associated with TRM task 144. Further, in some embodiments, one or more portions of work may have begun for a TRM task 144 with a task status indicator of On Hold. A task status indicator of Completed may indicate that TRM task 144 has been created and processed, as discussed above in connection with FIG. 4, that one or more TRM resources 142 have been associated with TRM task 144, and that work on TRM task 144 has been completed. A task status indicator of Canceled may indicate that TRM task 144 has been created, but that further work on TRM task 144 has been canceled. In some embodiments, a task status indicator of Canceled may also indicate that TRM task 144 has been processed, as discussed above in connection with FIG. 4, and that one or more TRM resources 142 have been associated with TRM task 144. Further, in some embodiments, a task status indicator of Canceled may reflect that one or more portions of work may have begun for a TRM task 144.

Based on the evaluation of the availability of TRM resources 142, TRM manager 140 may associate one or more TRM tasks 144 and one or more TRM resources 142 (step 730). In one embodiment, TRM manager 140 may associate one or more TRM tasks 144 with one or more TRM resources 142 using one or more discrete editable fields including, for example, drop-down boxes, alphanumeric entry fields, radio buttons, check boxes, scrollable lists, menu bars, and the like. In one exemplary embodiment, TRM manager 140 may assign a plurality of TRM resources 142 to a single TRM task 144. In another exemplary embodiment, TRM manager 140 may associate a plurality of TRM tasks 144 with one TRM resource 142. In some embodiments, TRM manager 140 may associate TRM resources 142 with TRM tasks 144 based on task and resource skills and/or task and resource skill levels. Thus, TRM manager 140 may assign a first TRM resource 142 with a first portion of TRM task 144 and may assign one or more other TRM resources 142 to one or more other portions of TRM task 144. In other embodiments, TRM manager 140 may associate TRM resources 142 with TRM tasks 144 based on, for example, (1) current task progress and/or status for one or more TRM tasks 144 currently associated with one or more TRM resources 142, (2) current task progress and/or status of the TRM task 144 that TRM manager 140 seeks to associate with one or more TRM resources 142, (3) priority (relative and/or absolute) of one or more TRM tasks 144 currently associated with one or more TRM resources 142, (4) priority (relative and/or absolute) of the TRM tasks 144 that TRM manager 140 seeks to associate with one or more TRM resources 142, etc.

In addition to associating one or more TRM tasks 144 and one or more TRM resources 142, TRM manager 140 may disassociate one or more TRM tasks 144 from one or more TRM resources 142. Disassociation may include, for example, (1) relieving TRM resource 142 of responsibility for one or more TRM tasks 144, (2) removing one or more TRM tasks 144 from TRM resource 142, (3) transferring one or more tasks from TRM resource 142, etc.

TRM manager 140 may disassociate one or more TRM tasks from one or more TRM resources by, for example, providing an indication of disassociation to TRM computing system 110. An indication of disassociation may be made using one or more discrete editable fields including, for example, drop-down boxes, alphanumeric entry fields, radio buttons, check boxes, scrollable lists, menu bars, and the like. Additionally and/or alternatively, one or more of these disclosed steps may be performed automatically using software. For example, TRM computing system 110 may automatically disassociate one or more TRM tasks 144 from TRM resource 142 if associating TRM task 144 with TRM resource 142 causes the workload of TRM resource 142 to exceed a certain predetermined workload amount.

To describe certain embodiments related to these features, consider the exemplary project manager, John Smith, for Business ABC. In this example, John Smith may create three tasks, TRM task 144a, TRM task 144b, and TRM task 144c. As shown in FIGS. 6a and 6b, TRM task 144a, TRM task 144b, and TRM task 144c may be shown graphically in an interface. The relative priority of the TRM tasks may be determined from the listed tasks in the graphical display. In this example, John Smith may also be a TRM manager 140a and may determine that TRM task 144b is a first priority, followed by TRM task 144c as a second priority, and TRM task 144a as a third priority.

As TRM manager 140a, John Smith, may access TRM computing system 110 to determine task skills and task skill levels associated with TRM tasks 144a, 144b, and 144c. For example, John Smith may associate a task skill of “dotNET” with each of TRM tasks 144a, 144b, and 144c. John Smith may also determine a priority associated with the “dotNET” task skill. For example, the “dotNET” task skill may be a first priority for TRM task 144b, a second priority for TRM task 144a, and a third priority for TRM task 144c.

Based on the determined task skills, task skill levels, and priorities, TRM computing system 110 may display a corresponding list of TRM resources 142 stored in database 115. In this example, TRM computing system 110 may display a list of TRM resources 142 having a resource skill corresponding to the “dotNET” task skill.

John Smith may then evaluate each displayed TRM resource 142 to determine a TRM resource 142 having a desired availability. For example, John Smith may determine that TRM resource 142, Jane Doe, is available. If John Smith determines that Jane Doe is available, John Smith may then associate TRM resource 144b with Jane Doe. Alternatively and/or additionally, John Smith may determine that TRM task 144b is a higher priority than one or more other TRM tasks 144 currently associated with Jane Doe, and John Smith may disassociate one or more other TRM tasks 144 from Jane Doe, thereby allowing Jane Doe more time to apply towards completion of TRM task 144b.

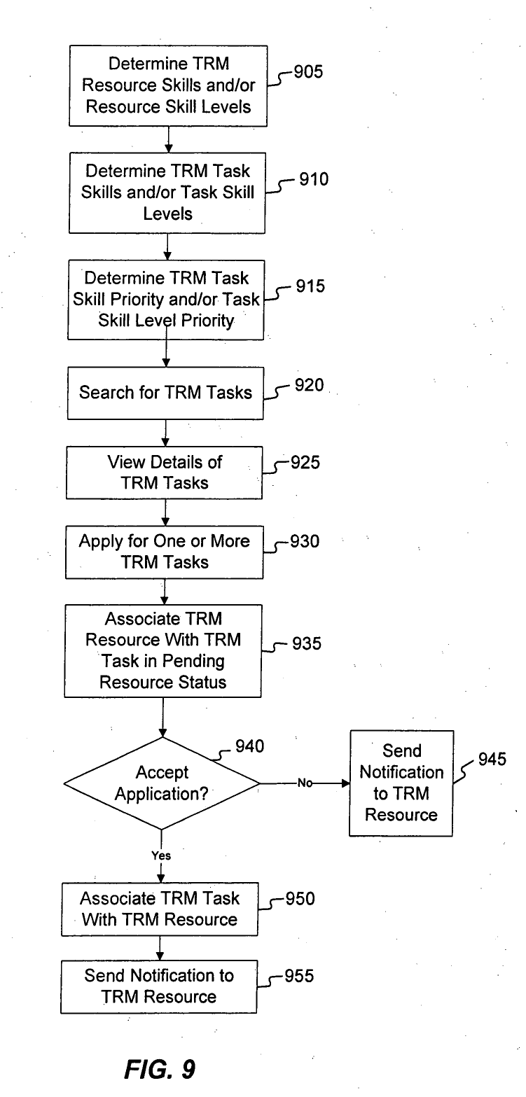

FIG. 9 illustrates a flowchart of an exemplary process for TRM resource and task assignment associated with TRM task and resource management, consistent with certain disclosed embodiments. The process of FIG. 9 may be performed by TRM computing system 110. For example, TRM computing system 110 may execute one or more software programs that may perform one or more of the process steps of FIG. 9.

Referring to FIG. 9, TRM manager 140 and/or TRM resource 142 may determine and store one or more resource skills and/or resource skill levels associated with one or more TRM resources 142 in TRM computing system 110 (step 905). In one exemplary embodiment, database 115 may store one or more lists and/or sets of selectable skills and/or selectable skill levels, and TRM manager 140 and/or TRM resource 142 may determine the one or more resource skills and/or resource skill levels from the one or more lists and/or sets via one or more discrete editable fields. For example, TRM manager 140 and/or TRM resource 142 may determine resource skills and/or resource skill levels using drop-down boxes, alphanumeric entry fields, radio buttons, check boxes, scrollable lists, menu bars, and the like. Additionally and/or alternatively, TRM computing system 110 may parse resource skills and/or resource skill levels from textual documents associated with TRM resources 142, such as, for example, resumes, curriculum vitaes, transcripts, job applications, surveys, etc. and stored in database 115. In addition, supporting text may also be entered for each resource skill and/or resource skill level. Once resource skills and resource skill levels are selected for a given TRM resource 142, they may then be stored in database 115 of TRM computing system 110.

For each TRM task 144, TRM manager 140 may determine and store one or more task skills and/or task skill levels in TRM computing system 110 (step 910). In one exemplary embodiment, database 115 may store one or more lists and/or sets of selectable skills and/or selectable skill levels, and TRM manager 140 and/or TRM resource 142 may determine the one or more task skills and/or task skill levels from the one or more selectable lists and/or sets via one or more discrete editable fields. For example, TRM manager 140 and/or TRM resource 142 may determine task skills and/or task skill levels using drop-down boxes, alphanumeric entry fields, radio buttons, check boxes, scrollable lists, menu bars, and the like. In addition, supporting text may also be entered for each task skill and/or task skill level. Once task skills and task skill levels are selected for a given TRM task 144, they may then be stored in database 115.

TRM manager 140 may determine a task skill priority and/or task skill level priority for each task skill and/or task skill level, respectively, of each TRM task 144 (step 915). TRM manager 140 may determine task skill and/or task skill level priority using one or more discrete editable fields including, for example, drop-down boxes, alphanumeric entry fields, radio buttons, check boxes, scrollable lists, menu bars, and the like. In one exemplary embodiment, TRM computing system 110 may use task skill priority and/or task skill level priority to, for example, prioritize one or more task skills relative to one or more other task skills. Additionally and/or alternatively, TRM manager 140 may use task skill priority and/or task skill level priority to associate one or more TRM resources 142 with a TRM task 144. For example, TRM manager 140 may associate a TRM resource 142 with a high resource skill level for a given resource skill with a TRM task 144 having a high priority for a corresponding task skill. As another example, TRM computing system 110 may automatically associate a TRM resource 142 with a high resource skill level for a given resource skill with a TRM task 144 having a high priority for a corresponding task skill.

TRM computing system 110 may indicate task skill priority using any type of communication mechanism, such as, for example, verbal, aural, alphanumeric, graphical, pictorial, color, and the like. In one exemplary embodiment, TRM computing system 110 may indicate the task skill priority by a number. In another exemplary embodiment, TRM computing system 110 may indicate task skill priority using a color. For example, red may indicate a first priority, orange may indicate a second priority, yellow may indicate a third priority, and so on. Alternatively and/or additionally, TRM computing system 110 may indicate task skill priority by the order of TRM tasks 144 in a table, list, or other data structure.

TRM resource 142 may search TRM computing system 110 for one or more TRM tasks 144 (step 920). TRM resource 142 may search TRM computing system 110 based on, for example, task skill, task skill level, task status, etc. In addition, TRM resource 142 may search TRM computing system 110 based on, for example, one or more of their own resource skills and/or resource skill levels as input in step 805 of FIG. 8. In response, TRM computing system may provide a list of TRM tasks 144 having the closest correspondence between task and resource skills and/or skill levels. In another exemplary embodiment, TRM resources 142 may initiate a search of database 115 of TRM computing system 110 by entering search data via one or more discrete editable fields, such as, for example, drop-down boxes, alphanumeric entry fields, radio buttons, check boxes, scrollable lists, menu bars, and the like. In response, TRM computing system 110 may provide a list of TRM tasks 144 to TRM resource 142 corresponding to the entered search data. In some embodiments, TRM computing system 110 may generate the list of TRM tasks 144 based on a single task and/or resource skill, multiple task and/or resource skills, priority of one or more task skills, resource skill level, etc. The displayed TRM tasks 144 may be listed in any order. For example, TRM computing 110 may list TRM resources 142 having a selected resource skill in ascending or descending alphabetical order by name, ascending or descending order of resource skill level for the associated selected resource skill, ascending or descending current work level of the TRM resource 142, etc. In addition to displaying the results, TRM computing system 110 may use other methods of outputting results including, for example, printing, copying, e-mailing, faxing, etc.

TRM resource 142 may view details of the displayed TRM tasks 144 (step 925). Details of the displayed TRM tasks 144 may include, for example, current TRM resources 142 associated with each TRM task 144, task progress, task status, task skills and/or skill levels, etc.

Once TRM resource 142 has viewed the list of TRM tasks 144, TRM resource 142 may apply for one or more TRM tasks 144 for possible association (step 930). In one embodiment, TRM resource 142 may apply for one or more TRM tasks 144 using a self-nomination process, where TRM resource 142 associates itself with one or more TRM tasks 144. TRM resource 142 may apply for one or more TRM tasks 144 using one or more discrete editable fields including, for example, drop-down boxes, alphanumeric entry fields, radio buttons, check boxes, scrollable lists, menu bars, and the like.

Once TRM resource 142 has applied for one or more TRM tasks 144, TRM computing system 110 may associate TRM resource 142, pending approval by TRM manager 140, with the one or more TRM tasks 144 for which TRM resource 142 has applied (step 935). When a TRM resource 142 has been associated with one or more TRM tasks 144, a resource status may be associated with the TRM resource 142. For example, in one exemplary embodiment, TRM computing system 110 may associate TRM resource 142 with the one or more TRM tasks 144 while in a Pending resource status. Other resource statuses may be used including, for example, Accept, Denied, etc. When a resource status is set to Accept, it may indicate that the application of TRM resource 142 for a TRM task 144 has been accepted. When a resource status is set to Denied, it may indicate that the application of TRM resource 142 has been denied. In one exemplary embodiment, TRM computing system 110 may automatically send a notification to TRM manager 140. TRM computing system 110 may send notification using, for example, mail, fax, TRM computing system 110 notification, electronic mail, electronic messaging, and the like. The notification may include information associated with the request from TRM resource 142 be associated with one or more TRM tasks 144.

In response to the application, TRM manager 140 may determine whether or not to accept the application of TRM resource 142 for TRM task 144 (step 940). TRM manager may make the determination based on an evaluation of one or more resource skills and/or resource skill levels, task skills and/or task skill levels, task priority, task status, etc. associated with TRM resource 142 and/or TRM task 144.

If TRM manager 140 accepts the application of TRM resource 142, TRM manager 140 may associate TRM resource 142 with TRM task 144 (step 950). TRM manager 140 may associate TRM task 144 with TRM resource 142 using one or more discrete editable fields including, for example, drop-down boxes, alphanumeric entry fields, radio buttons, check boxes, scrollable lists, menu bars, and the like. Alternatively and/or additionally, TRM computing system 110 may automatically associate TRM task 144 with TRM resource 142 when one or more predetermined conditions are met. Predetermined conditions may include, for example, a certain number of resource skills and/or resource skill levels corresponding to task skills and/or task skill levels, a certain number of resource skills and/or resource skill levels corresponding to task skills and/or task skill levels having a certain priority, task progress, TRM resource 142 availability, etc. In one exemplary embodiment, when TRM resource 142 is associated with TRM task 144, the resource status of TRM resource 142 may be changed automatically by TRM computing system 110. For example, the resource status may be automatically changed from Pending to Active when the application of TRM resource 142 for TRM task 144 is accepted.

If TRM manager 140 accepts the application, TRM computing system 110 may send a notification to TRM resource 142 (step 955). TRM computing system 110 may send notification using, for example, mail, fax, TRM computing system 110 notification, electronic mail, electronic messaging, and the like.

If TRM manager 140 declines to accept the application of TRM resource 142 for TRM task 144, TRM manager 140 may deny the application of TRM resource 142 (step 940, No). TRM manager 140 may deny the application of TRM resource 142 using one or more discrete editable fields including, for example, drop-down boxes, alphanumeric entry fields, radio buttons, check boxes, scrollable lists, menu bars, and the like. When the application of TRM resource 142 is denied, TRM computing system 110 may automatically change the resource status of TRM resource 142. In one exemplary embodiment, TRM computing system 110 may automatically change the resource status from Pending to Denied.

If TRM manager 140 denies the application, TRM computing system 110 may send a notification to TRM resource 142 (step 945). TRM computing system 110 may send notification using, for example, mail, fax, TRM computing system 110 notification, electronic mail, electronic messaging, and the like.

To describe these features of the disclosed embodiment, consider Jane Doe, a TRM resource 142, using the information displayed in exemplary interface 500, shown in FIG. 5. Jane Doe may access TRM computing system 110 and select a task skill from a drop-down box as shown in interface 500. In this example, in response to Jane Doe selecting a COBOL task skill, TRM computing system 110 may display a list of TRM tasks 144 associated with the COBOL task skill. As shown in interface 500, each TRM task 144 may be listed along with a determined priority value. In one embodiment, Jane Doe may select a TRM task 144 to display additional information associated with the TRM task 144.

Also, Jane Doe may apply for a TRM task 144 having the highest priority value, such as, for example, “Create Test Scripts & Test,” which has a priority value of 400. To do so, Jane Doe may select “Create Test Scripts & Test,” and appropriate application fields. In response, TRM computing system 110 may associate Jane Doe with “Create Test Scripts & Test” in a Pending resource status. Once TRM Manager 142 has accepted Jane Doe's application for “Create Test Scripts & Test,” TRM computing system 110 may change the resource status from Pending to Accept.

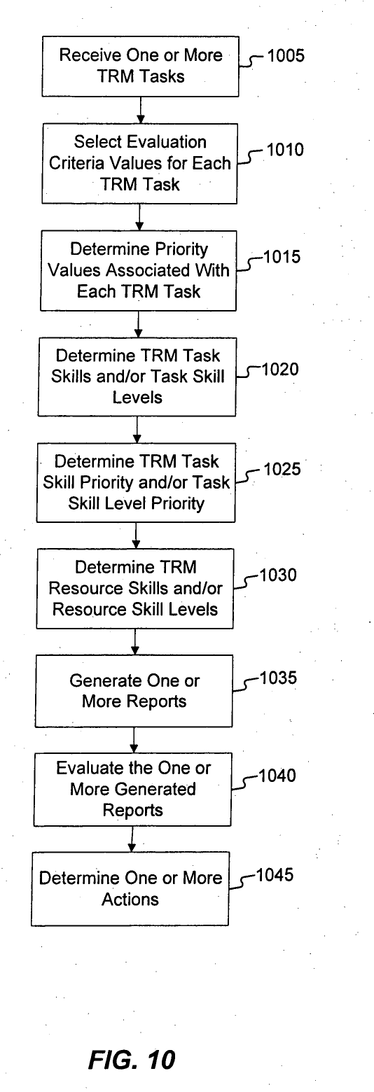

FIG. 10 illustrates a flowchart of an exemplary process for TRM resource and task assignment associated with TRM task and resource management, consistent with certain disclosed embodiments. The process of FIG. 10 may be performed by TRM computing system 110. For example, TRM computing system 110 may execute one or more software programs that may perform one or more of the process steps of FIG. 10.

Referring to FIG. 10, once the evaluation criteria, evaluation criteria values, evaluation criteria weights, and/or evaluation criteria value weights have been determined, as discussed above in connection with FIG. 2, TRM computing system 110 may receive one or more TRM tasks 144 (step 1005). In one embodiment, the one or more TRM tasks 144 may each be generated by a user. The user may be any person or group of persons associated with a business or other entity and may include, for example, TRM managers 140, TRM resources 142, owners, employees, agents, customers, vendors, business partners, etc. The user may generate one or more TRM tasks 144 using a computing system operable to communicate with TRM computing system 110. Alternatively and/or additionally, one or more TRM tasks 144 may be generated automatically using computer software and/or hardware, etc. In one exemplary embodiment, TRM computing system 110 may store TRM tasks 144 in database 115.

From the available choices one or more evaluation criteria and one or more associated evaluation criteria values provided by TRM computing system 110, TRM manager 140 may select one or more evaluation criteria values for each TRM task 144 (step 1010). For example, referring to FIGS. 3a-3d, TRM manager 140 may select the following evaluation criteria values for TRM task 144: Dollar Value=$75,000-$100,000, Level of Effort=6 months-1 year, Business Value=Medium, and Risk Value−Medium risk if not completed. In addition, in some embodiments, TRM manager 140 may enter evaluation criteria values using a text field. Alternatively and/or additionally, evaluation criteria values associated with each evaluation criterion for a specific TRM task 144 may be selected by TRM resource 142 or any other person and/or group of persons associated with the business entity.

Based on the selected evaluation criteria values, such as that discussed above in connection with step 1010, and/or the weighting values associated with each evaluation criteria and/or evaluation criteria value, such as that discussed above in connection with step 215 of FIG. 2, TRM computing system 110 may calculate one or more priority values for each TRM task 144 (step 1015). In one embodiment, TRM computing system 110 may execute software that determines a priority value by a mathematical calculation or formula based on the selected evaluation criteria values and their associated weighted value for a given business entity.

TRM computing system 110 may indicate the determined priority value for each TRM task 144 using any communicating mechanism, such as, for example, verbal, aural, alphanumeric, graphical, pictorial, color, and the like. In one exemplary embodiment, TRM computing system 110 may indicate the priority value by a number. For example, a priority value number that is relatively larger than one or more other priority value numbers may indicate a higher priority, and a priority value number that is relatively smaller than one or more other priority value numbers may indicate a lower priority. In another exemplary embodiment, TRM computing system 110 may indicate the priority value using a color. For example, red may indicate the highest priority, orange may indicate the second highest priority, yellow may indicate the third highest priority, and so on. Alternatively and/or additionally, TRM computing system 110 may indicate priority by the order of TRM tasks 144 in a table, list, or other data structure.

For each TRM task 144, TRM manager 140 may determine one or more task skills and/or task skill levels (step 1020). Alternatively and/or additionally, TRM resource 142 and/or other persons or groups of persons associated with the business entity may determine one or more task skills and/or task skill levels. TRM computing system 110 may store the determined task skills and/or task skill levels in database 115.

TRM manager 140 and/or TRM resources 142 may determine one or more resource skills and/or resource skill levels associated with one or more TRM resources 142 (step 1030). TRM computing system 110 may store the determined resource skills and/or resource skill levels in database 115.

Once data associated with TRM tasks 144 and/or TRM resources 142 has been determined and stored in TRM computing system 110, TRM computing system 110 may generate one or more reports (step 1035). In one exemplary embodiment, the one or more reports may include data for one or more TRM tasks 144, one or more TRM resources 142, or any combination thereof. Additionally and/or alternatively, the one or more reports may include information reflecting, for example, one or more evaluation criteria, one or more evaluation criteria values, one or more evaluation criteria weights, one or more evaluation criteria value weights, one or more priority values which may be associated with each TRM task 144, one or more resource skills and/or resource skill levels, one or more task skills and/or task skill levels, priority of one or more task skills and/or task skill levels, progress of one or more TRM tasks 144, status of one or more TRM tasks 144, resources status of one or more TRM resources 142, etc. TRM computing system 110 may generated the one or more reports automatically, on demand, or any combination thereof. For example, TRM computing system 110 may generate the one or more reports on a regular basis, such as, for example, monthly, bimonthly, weekly, bi-weekly, daily, etc.

TRM manager 140 may evaluate the one or more generated reports (step 1040). Evaluation may include analysis of data contained within the one or more generated reports, analysis of data between reports, and the like.

Based on the evaluation, TRM manager 140 may then determine one or more actions (step 1045). The one or more determined actions may include, for example, associating one or more additional TRM resources 142 with one or more TRM tasks 144, disassociating one or more TRM resources 142 from one or more TRM tasks 144, changing a status for one or more TRM tasks (e.g., changing status from New/Not Started to On Hold, changing status from New/Not Started to In Process, changing status from In Process to Canceled, etc.), etc. In addition, based on the evaluation, TRM manager 140 may identify one or more TRM resources 142 requiring more training and/or development. For example, evaluation of the one or more reports may indicate a shortage of TRM resources having a particular resource skill. TRM manager 140 may then identify one or more TRM resources 142, and initiate development of the identified one or more TRM resources 142 in that skill. In one embodiment, TRM manager 140 may request one or more TRM resources 142 to increase or improve an associated resource skill and/or resource skill level. TRM manager 140 may, for example, request TRM resource 142 to attend one or more training classes, to pursue on-the-job training, complete a degree, pursue an advanced degree, obtain licensing and/or certification, etc. In addition, TRM manager 140 may develop a training and/or development plan for one or more TRM resources 142 as part of a feedback or improvement process, plan for one or more future training activities for a group of TRM resources 142 (e.g., on-site training, lunch-time learning activities, etc.), and the like.

### INDUSTRIAL APPLICABILITY

The disclosed embodiments may be implemented with processes involving task and resource management. The disclosed embodiments may achieve improved performance of managing tasks and resources. In particular, the disclosed embodiments may provide improved data input, tracking, and auditing of tasks and resources.

In addition, the disclosed embodiments may be used for managing tasks for any type of individual and/or group. For example, the disclosed embodiments may be used in a management environment where one or more managers may seek to view and/or visually display the priority of upcoming tasks. As another example, the disclosed embodiments may be used in a business partnership environment where the business entity may seek to manage or view tasks associated with one or more business partners. Other types of businesses may include financial institutions, manufacturing environments, software development, etc. Further, the disclosed embodiments may be applicable in any environment that has a need for improved tracking, viewing, and/or managing tasks and resources. For example, volunteer organizations, government projects, and educational institutions may also benefit from the improved tracking of tasks or resources.

The disclosed embodiments are not limited to that described or illustrated in the figures. For example, the disclosed embodiments may be implemented with fewer or greater number of steps than those shown in FIGS. 2, 4, 7, 9, and 10. For example, the determining evaluation criteria step 205 shown in FIG. 2 may include evaluation sub-criteria, and additional process steps may be performed for the evaluation sub-criteria. Further, evaluation sub-criteria values may be determined for each evaluation sub-criteria and, once a task is received, evaluation sub-criteria values may be selected. In addition, referring to FIG. 4, TRM tasks 144 may be prioritized in multiple different formats, and may be prioritized in parallel. This may generate and display a numerical prioritization value associated with TRM task 144 in a graph such as that shown in FIGS. 6a and 6b. Further, TRM computing system may continuously receive one or more TRM tasks 144, and may repeat the process steps shown in FIGS. 4 and 10. For instance, TRM computing system 110 may repeat certain process steps periodically (e.g., daily, weekly, monthly, etc.), after a certain number of TRM tasks 144 have been received (e.g., every 10, 20, 30, etc.), or randomly (e.g., at the discretion of TRM manager 140 and/or TRM resource 142, when requested, etc.).

It will be apparent to those skilled in the art that various modifications and variations can be made in the system and method for managing tasks and resources. It is intended that the specification and examples be considered as exemplary only, with a true scope of the disclosed embodiments being indicated by the following claims and their equivalents.

What is claimed is:

1. A method for managing one or more tasks or human resources, comprising:
storing a plurality of first tasks, each first task including at least one first task skill;
receiving a search request, the search request including at least one search request skill;
determining, based on the plurality of first tasks, if one or more of the at least one first task skills corresponds to the at least one search request skill;
determining one or more second tasks when it is determined that one or more of the at least one first task skills corresponds to the at least one search request skill, wherein the one or more second tasks are determined from the plurality of first tasks;
providing the determined one or more second tasks to a human resource;
receiving a request from the human resource to be associated with at least one of the determined one or more second tasks; and
associating the human resource with the at least one of the determined one or more second tasks.

2. The method as in claim 1, wherein the one or more second tasks includes at least one second task skill, and at least one of the at least one second task skills corresponds to the at least one search request skill.

3. The method as in claim 1, wherein associating the human resource further includes:
associating the human resource with the at least one of the determined one or more second tasks with a pending approval status.

4. The method as in claim 1, further including:
receiving approval to associate the human resource with the at least one of the determined one or more second tasks.

5. The method as in claim 1, wherein receiving the search request further includes:
receiving at least one human resource skill associated with the human resource; and
determining the at least one search request skill based on the received at least one human resource skill.

6. The method as in claim 1, wherein receiving the search request further includes:
receiving at least one human resource skill that is determined by the human resource; and
determining the at least one search request skill based on the received at least one human resource skill.

7. The method as in claim 1, wherein receiving the search request further includes:
receiving at least one human resource skill level associated with the human resource; and
determining the at least one search request skill based on the received at least one human resource skill level.

8. A computer-readable medium including instructions for performing, when executed by a processor, a method for managing one or more tasks or human resources, the method comprising:
storing a plurality of first tasks, each first task including at least one first task skill;
receiving a search request, the search request including at least one search request skill;
determining, based on the plurality of first tasks, if one or more of the at least one first task skills corresponds to the at least one search request skill;
determining one or more second tasks when it is determined that one or more of the at least one first task skills corresponds to the at least one search request skill, wherein the one or more second tasks are determined from the plurality of first tasks;
providing the determined one or more second tasks to a human resource;
receiving a request from the human resource to be associated with at least one of the determined one or more second tasks; and
associating the human resource with the at least one of the determined one or more second tasks.

9. A computer-readable medium as in claim 8, wherein the one or more second tasks includes at least one second task skill, and at least one of the at least one second task skills corresponds to the at least one search request skill.

10. A computer-readable medium as in claim 8, wherein associating the human resource further includes:
associating the human resource with the at least one of the determined one or more second tasks with a pending approval status.

11. A computer-readable medium as in claim 8, wherein the method further includes:
receiving approval to associate the human resource with the at least one of the determined one or more second tasks.

12. A computer-readable medium as in claim 8, wherein receiving the search request further includes:
receiving at least one human resource skill associated with the human resource; and
determining the at least one search request skill based on the received at least one human resource skill.

13. The computer-readable medium as in claim 8, wherein receiving the search request further includes:
receiving at least one human resource skill determined by the human resource; and
determining at least one search request skill based on the received at least one human resource skill.

14. The computer-readable medium as in claim 8, wherein receiving the search request further includes:
receiving at least one human resource skill level associated with the human resource; and
determining at least one search request skill based on the received at least one human resource skill level.

15. A system for managing one or more tasks or human resources, comprising:
at least one memory storing data and instructions; and
at least one processor configured to access the memory and execute instructions to:
storing a plurality of first tasks, each first task including at least one first task skill;
receive a search request, the search request including at least one search request skill;
determine, based on the plurality of first tasks, if one or more of the at least one first task skills corresponds to the at least one search request skill;
determine, when it is determined that one or more of the at least one first task skills corresponds to the at least one search request skill, one or more second tasks;
provide the determined one or more second tasks to a human resource;
receive a request from the human resource to be associated with at least one of the determined one or more second tasks; and
associate the human resource with the at least one of the determined one or more second tasks.

16. The system as in claim 15, wherein the one or more second tasks include at least one second task skill, and at least one of the at least one second task skill corresponds to the at least one search request skill.

17. The system as in claim 16, wherein to associate the human resource further includes:
associating the human resource with the at least one of the determined one or more second tasks with a pending approval status.

18. The system as in claim 16, wherein the at least one processor is further configured to:
receive approval to associate the human resource with the at least one of the determined one or more second tasks.

19. The system as in claim 18, wherein to receive the search request further includes:
receiving at least one human resource skill associated with the human resource; and
determining the at least one search request skill based on the received at least one human resource skill.

20. The system as in claim 18, wherein to receive the search request further includes:
receiving at least one human resource skill level associated with the human resource; and
determining the at least one search request skill based on the received at least one human resource skill level.
